(19) United States
(12) Patent Application Publication
(10) Pub. No.: US 2011/0013779 A1
(43) Pub. Date: Jan. 20, 2011

(54) APPARATUS FOR TESTING AUDIO QUALITY OF AN ELECTRONIC DEVICE

(75) Inventor: John Arthur, Santa Clara, CA (US)

Correspondence Address: KRAMER LEVIN NAFTALIS & FRANKEL LLP, 1177 Avenue of the Americas, New York, NY, 10036, US

(73) Assignee: Apple Inc., Cupertino, CA (US)

(21) Appl. No.: 12/505,018

(22) Filed: Jul. 17, 2009

(51) Int. Cl. H04R 29/00

(52) U.S. Cl. 381/56

(57) ABSTRACT

This is directed to a system for testing the quality of the audio output components of an electronic device. In particular, this is directed to measuring and quantifying the software and hardware components of audio output by an electronic device. The electronic device can be connected to a testing apparatus that provides instructions for playing back particular audio files, recording the audio output by an electronic device, and comparing the recorded output with a baseline. The testing apparatus can analyze audio files generated using different attributes (e.g., containers, codecs, or bit rates) to ensure that all files that could be played back play back properly. To ensure that the testing apparatus correctly associates recorded audio outputs with audio test files, the content of each played back audio test file can identify the attributes of the audio test file. For example, each attribute can be associated with a 1 kHz tone at a particular frequency, such that the testing apparatus can identify the frequencies of detected 1 kHz tones to identify the attributes of the played back audio test file.

### BACKGROUND OF THE INVENTION

This is directed to an apparatus for measuring the quality of audio output by an electronic device in an efficient and repeatable manner. In particular, this is directed an apparatus for quantifying the quality of individual attributes of an audio file output by an electronic device.

Different electronic devices can be operative to output audio for users to listen. In particular, many electronic devices can have media playback functionality for providing an entertainment experience to users. The electronic devices can play back many types of media files, including for example media files having audio components. The audio components of media files can be encoded or digitized using many different approaches. For example, audio can be encoded as mono or stereo (or with any suitable number of channels). As another example, audio can be encoded using different CODECs. As still another example, audio can be encoded with different formats or containers, data rates, bit depths, or other attributes defining the manner in which the audio is recorded and digitally stored.

To output a recorded audio file, an electronic device can decode the file using both hardware and software. For example, hardware can include a digital to analog converter, and software can include a CODEC. Each of the hardware and software can operate with different levels of effectiveness based on the attributes of the audio files being played back. For example, the quality of the audio output by the hardware or software can vary based on the container used for the audio file. As another example, the electronic device can vary in effectiveness and accuracy in outputting audio for audio files having different bit depths or sample rates (e.g., variable sample rates vs. different levels of fixed sample rates).

To comprehensively test the electronic device, different audio files can be generated, where each file has slightly different attribute configurations, and the output audio can then be compared to an expected output determined from the generated audio file (e.g., compare the output of the electronic device playing back an audio file with the original audio source used to generate the audio file). When a large number of attributes can be changed, however, this approach can be very time consuming. To speed up the process, audio files can be generated using different attributes and automatically played back and recorded. When the same audio content is played back with different file configurations, a user of the test apparatus may not know which configuration is being played back, or which audio file attribute configuration corresponds to a recording of the testing apparatus. Although the user can attempt to rely on file names and the order in which the files were played back and recorded, this approach can be uncertain, in particular if the file names do not describe the file attributes, if the order in which audio test files were played back or recordings were stored is unknown, or if the testing apparatus malfunctions and only some recordings are actually stored.

### SUMMARY OF THE INVENTION

This is directed to an apparatus for testing the quality of audio output by an electronic device. In particular, this is directed to an apparatus for defining and analyzing an audio file that includes 1 kHz tunes at different frequencies, each frequency associated with a particular attribute of the audio file.

An electronic device can use both hardware components and software to decode and output audio associated with an audio file. The software and hardware components can process audio files differently based on the attributes of the audio file. For example, the software decoders for decoding audio files encoded with different CODECs, or for processing different file containers can output audio that has slight variations or differences. As another example, audio processing hardware can convert digital audio files to analog audio differently based on the bit depth of the audio file.

To ensure that an electronic device is properly processing all variations of audio files played back by the device, the electronic device can be connected to a testing apparatus for verification (e.g., to perform a parameter sweep using the testing apparatus). Using the testing apparatus, an audio file of known content can be generated using known attributes. The audio file can then be provided to the electronic device, played back, and the audio output of the electronic device can be recorded by the testing apparatus. The testing apparatus can then compare the recorded audio output with the known audio content to determine whether the electronic device is providing an acceptable output.

The electronic device can play back audio files encoded, digitized or generated using different file attributes. For example, different audio files can have different containers, CODECs, bit rates, bit depths, numbers of channels, or any other attribute specifying a manner in which audio is digitized and stored. Each attribute can have several possible values, including for example a large range of values (e.g., bit rates in the range of 32 kbit/s to 2 Mbit/s, or variable bit rates). Because there may be a large number of attributes that can change, as well as a large number of possible values for each attribute, it can be difficult to keep track of the generated audio files and of the recordings of the played back audio files. In particular, it may be difficult keeping track of which audio file and recording are associated with particular configurations of attributes.

To allow for efficient management of the testing of audio files, the testing apparatus can generate audio files in which each attribute value of audio files is associated with a 1 kHz tone at a predetermined frequency. The content of the audio file is then selected to be a series of 1 kHz tones at frequencies corresponding the filed attributes. The generated audio files can then be played back by the device and recorded by the testing apparatus. By analyzing the frequencies of the particular 1 kHz frequency tones of a played back audio test file and a the audio output recorded by the testing apparatus, the testing apparatus can ensure that the proper audio files were played back, and determine the attributes of the audio file corresponding to each recorded audio output.

The testing apparatus can determine whether a recording of a played back audio file is appropriate or satisfactory using any suitable approach. In some embodiments, the testing apparatus can include a database or other source of testing data to which the testing apparatus can compare recorded audio. Data reflecting the recorded audio, as well as data reflecting the adequacy of the recorded audio can be stored at any suitable location, including for example within a database of testing information. The testing apparatus can process the recorded audio using any suitable approach, including for example using a fast Fourier transform (FFT) to detect the peaks in the audio wave that correspond to the 1 kHz tones.

In addition to parameter sweeps, the testing apparatus can be used to perform any other suitable type of test, including for example volume tests. In a volume test, a single 1 kHz tone of known frequency can be played back at each volume level to determine the actual output level of each volume value for the electronic device. Other tests can be performed, including for example tests relating to displayed information (e.g., video or images), for which different frequencies of color can be associated with image of video file attributes.

### BRIEF DESCRIPTION OF THE DRAWINGS

The above and other features of the present invention, its nature and various advantages will be more apparent upon consideration of the following detailed description, taken in conjunction with the accompanying drawings in which:

FIG. 1 is a block diagram of an illustrative electronic device operative to play back audio in accordance with one embodiment of the invention;

FIG. 2 is a block diagram of an illustrative testing system in accordance with one embodiment of the invention.

FIG. 3 is a flowchart of an illustrative process for testing the quality of played back audio in accordance with one embodiment of the invention;

FIG. 4 is a schematic view of audio content for an audio test file in accordance with one embodiment of the invention; and

FIG. 5 is a schematic view of a representation of an analog audio signal generated by an electronic device in accordance with one embodiment of the invention.

### DETAILED DESCRIPTION

An electronic device can include several components that interact to generate an audio output. For example, an electronic device can include both software and audio circuitry that combine to generate the audio output. Before selling or shipping an electronic device, a manufacturer may wish to ensure that the different audio output components interact properly to output audio of suitable quality. The manufacturer can test the audio output components using a subjective test (e.g., having dedicated listeners listen to audio played back by the device and provide a rating or other subjective ranking). Alternatively, the electronic device can be connected to a testing apparatus that provides a mechanism for objectively measuring and quantifying the audio output by the electronic device. In some embodiments, the testing apparatus can allow for distinguishing the output of each of audio output components of the electronic device (e.g., distinguish the output of the CODEC and of the digital to analog converter circuitry).

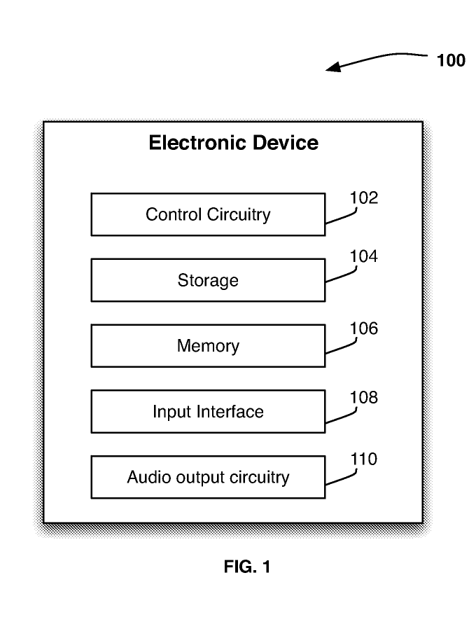

FIG. 1 is a block diagram of an illustrative electronic device operative to play back audio in accordance with one embodiment of the invention. Electronic device 100 can include processor or control circuitry 102, storage 104, memory 106, input interface 108, and audio output circuitry 110. In some embodiments, one or more of electronic device components 100 can be combined or omitted (e.g., combine storage 104 and memory 106). In some embodiments, electronic device 100 can include other components not combined or included in those shown in FIG. 1 (e.g., a power supply or a bus), or several instances of the components shown in FIG. 1. For the sake of simplicity, only one of each of the components is shown in FIG. 1.

Processor 102 can include any processing circuitry operative to control the operations and performance of electronic device 100. For example, processor 100 can be used to run operating system applications, firmware applications, media playback applications, media editing applications, or any other application. In some embodiments, a processor can drive a display and process inputs received from a user interface.

Storage 104 can include, for example, one or more storage mediums including a hard-drive, solid state drive, flash memory, permanent memory such as ROM, any other suitable type of storage component, or any combination thereof. Storage 104 can store, for example, media data (e.g., music and video files), application data (e.g., for implementing functions on device 100), firmware, user preference data (e.g., media playback preferences), contacts and calendar information, authentication information, lifestyle or exercise information, transaction information, wireless connection information, and any other suitable data or any combination thereof. Memory 106 can include cache memory, semi-permanent memory such as RAM, and/or one or more different types of memory used for temporarily storing data. In some embodiments, memory 106 can also be used for storing data used to operate electronic device applications, or any other type of data that can be stored in storage 104. In some embodiments, memory 106 and storage 104 can be combined as a single storage medium.

Input interface 108 can include any suitable interface for providing inputs to input/output circuitry of the electronic device. Input interface 108 can include any suitable input interface, such as for example, a button, keypad, dial, a click wheel, a touch interface (e.g., multi-touch screen, or near-touch interface), or any combination thereof. The input interface can detect user inputs using at least one sensing element, such as a mechanical sensor, resistive sensor, capacitive sensor, a multi-touch capacitive sensor, or any other suitable type of sensing element. In some embodiments, the input interface can include a port through which the electronic device can be connected to a testing apparatus. The testing apparatus can then send control signals (e.g., instructions to play back particular media files) or provide other data (e.g., provide the media files to play back) to input interface 108 via the port.

Audio output circuitry 110 can include a digital to analog converter (DAC) for converting digital data reflecting particular audio to an analog stream corresponding to the audio. The DAC can be connected to an amplifier, speaker (e.g., a headphone or headset), or a connector for transmitting analog signals to an amplifier or speaker (e.g., an audio jack, or wireless radio for transmitting signals reflecting the audio). In some embodiments, audio output circuitry 110 can include a connector or port for transmitting digital audio to a remote DAC and amplifier. Audio output circuitry 110 can include any other component for generating analog signals from digital media, including for example several DACs, or other components for processing digital or analog audio signals.

One or more of input interface 108 and audio output circuitry 110 may be coupled to input/output circuitry. The input/output circuitry may be operative to convert (and encode/decode, if necessary) analog signals and other signals into digital data. In some embodiments, the input/output circuitry can also convert digital data into any other type of signal, and vice-versa. For example, the input/output circuitry may receive and convert physical contact inputs (e.g., from a touch pad), physical movements (e.g., from a mouse or sensor), analog audio signals (e.g., from a microphone), or any other input. As another example, the input/output circuitry can receive digital signals corresponding to audio, and convert the signals to analog signals that may be output by audio output circuitry 110. The digital data can be provided to and received from processor 102, storage 104, memory 106, or any other component of electronic device 100. In some embodiments, several instances of the input/output circuitry can be included in electronic device 100.

In some embodiments, electronic device 100 may include a bus operative to provide a data transfer path for transferring data to, from, or between control processor 102, storage 104, memory 106, input interface 108, audio output circuitry 110, and any other component included in the electronic device. Such other components can include, for example, communications circuitry, positioning circuitry, motion detection circuitry, or any other suitable component. In some embodiments, communications circuitry can be used to connect the electronic device to a host device from which media such as audio, metadata related to the audio, and playlists or other information for managing the received audio.

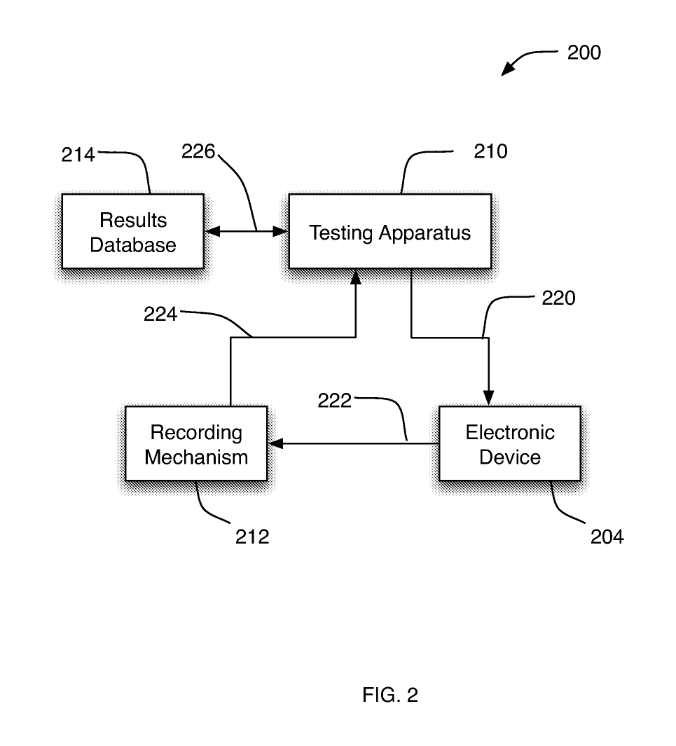

The electronic device can be placed in a testing apparatus for quantifying the audio output of different audio files played back by the electronic device. FIG. 2 is a block diagram of an illustrative testing system in accordance with one embodiment of the invention. Testing system 200 can include testing apparatus 210 operative to generate audio test files that electronic device 204 can play back, and to analyze the resulting output of the electronic device. Testing apparatus 210 can be coupled to recording mechanism 212 for receiving and recording audio outputs generated by electronic device 204. Recording mechanism 212 can include any suitable recording mechanism, including for example an analog to digital converter for creating digital files representing the audio output of the device. The digital audio can be stored using any suitable audio format, including for example using a lossless encoding structure. In some embodiments, testing system 200 can include results database 214 used to store raw data, test results, testing criteria, or any other information relating to conducting or reviewing tests of electronic device output components. Testing apparatus 210, recording mechanism 212 and results database 214 can include several distinct devices in communication, or the functionality of two or more of the devices can be combined in a fewer devices (e.g., combine the content and functionality of the testing apparatus 210, recording mechanism 212 and results database 214 in testing apparatus 210). In some embodiments, a single results database 214 can be coupled to several instances of testing apparatus 210, so that many testing apparatuses can be used simultaneously to test several electronic devices (although only one of each is shown in system 200 to avoid overcomplicating the drawing).

Testing apparatus 210 can provide one or both of power and data transfers to electronic device 220 via communications path 220. Communications path 220 can support wired or wireless communications using any suitable communications protocol. For example, communications path 220 can support communications using Wi-Fi (e.g., a 802.11 protocol), Ethernet, Bluetooth®, radio frequency systems, cellular networks (e.g., GSM), infrared, TCP/IP (e.g., any of the protocols used in each of the TCP/IP layers), Bluetooth®, radio frequency systems, infrared, iAP (iPod Accessory Protocol), or any other communications protocol or combination of communications protocols. Audio output by electronic device 204 can be transmitted to recording mechanism 212 via communications path 222, which can include some or all of the features of communications path 220. To ensure that the output audio is properly recorded, communications path 220 can include a path for transmitting analog signals output by the electronic device (e.g., via an audio jack). The materials used for creating communications path 220 can be selected for high audio fidelity to ensure that the audio recorded by recording mechanism 212 is a faithful reproduction of the audio output of electronic device 204.

Testing system 200 can include communications path 224 between recording mechanism 212 and testing apparatus 210 for transmitting the recording of the audio output produced by recording mechanism 212. In addition, testing system 200 can include communications path 226 for transmitting information between testing apparatus 210 and results database 214. Communications path 224 and 226 can include any of the features described above in connection with communications path 220.

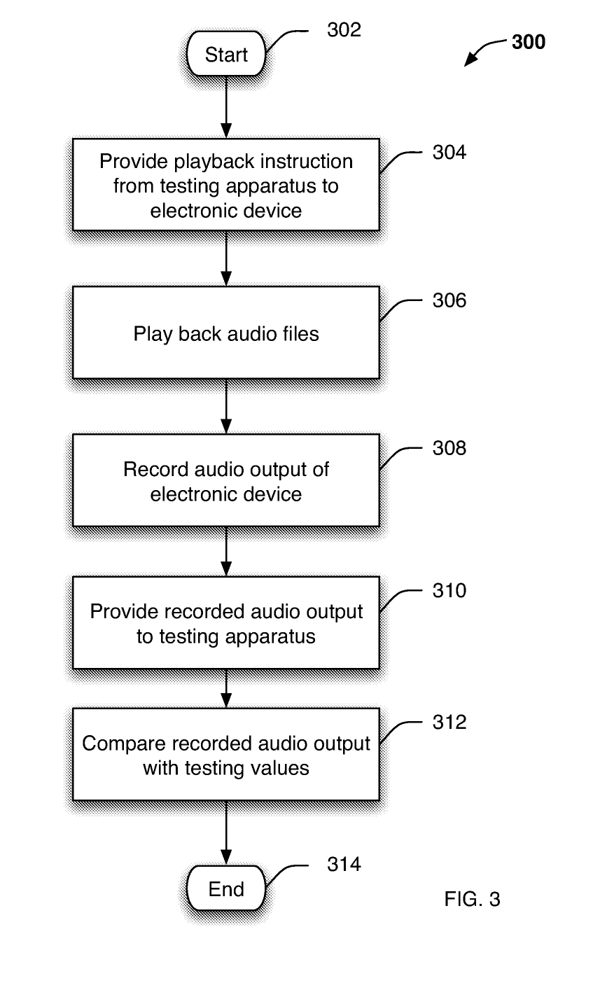

Using the testing apparatus, a user can test the quality of audio played back by the electronic device. FIG. 3 is a flowchart of an illustrative process for testing the quality of played back audio in accordance with one embodiment of the invention. Process 300 can begin at step 302. At step 304, the testing apparatus can provide a playback instruction to an electronic device being tested. For example, the testing apparatus can provide an instruction identifying a particular audio file and instructing the device to play back the identified audio file (e.g., using the iAP protocol). As another example, the electronic device can instead or in addition identify a playlist of audio files to play back in sequence. The audio files can be locally stored on the electronic device, or can instead or in addition be provided by the testing apparatus to the electronic device (e.g., as part of the playback instruction).

At step 306, the electronic device can play back audio files. For example, the electronic device can play back particular audio files identified or selected by the testing apparatus. To play back an audio item, the electronic device can use software to decode an audio file or otherwise prepare an audio file for conversion from digital to analog. For example, the software can include CODEC for decoding (in software) a container and digital audio file format. The electronic device can, in some embodiments, use hardware to convert a digital audio file to analog signals that can be output to an amplifier or speaker. For example, the electronic device can include a DAC for generating analog signals corresponding to the digital audio.

At step 308, a recording mechanism can be used to record the audio output of the electronic device. For example, the recording mechanism can include an analog-to-digital converter (ADC) for converting received analog signals depicting the audio output of the device to digital signals. The digital signals can be stored using any suitable approach, including for example using a particular audio file format or container. In some embodiments, the recording mechanism can apply a fast Fourier transform (FFT) to the audio signals to generate a binary representation of an analog waveform that can be analyzed by the testing apparatus. At step 310, the recording mechanism can provide the recorded audio output to the testing apparatus. For example, the recording mechanism can provide a FFT representation of the audio output to the testing apparatus for review. As another example, the recording mechanism can provide a digital audio file representing the recorded audio output to a testing apparatus.

At step 310, the testing apparatus can compare the received recorded audio output with known testing values. For example, the testing apparatus can provide the received audio output information to a results database, and determine whether the received audio output satisfies thresholds set in the database. The database can have any suitable number or type of threshold values, including for example values set for each type of audio file played back (e.g., based on the attributes of the audio file), the particular electronic device (e.g., the device hardware capabilities), the software build of the device, or any other type of threshold value. In some embodiments, the results database can define a tolerance for each of the values, such that audio outputs that are within the tolerance associated with each threshold value pass the audio output test. The results of the audio test can also be stored Process 300 can then end at step 312.

In some embodiments, the testing system can be used to independently test the software and hardware components of the audio output circuitry of the electronic device. In one implementation, the testing apparatus can provide an audio file to the electronic device. The software of the device can decode the file, and provide the decoded stream simultaneously to the testing apparatus and to the device hardware components. The testing apparatus can then do a bit-by-bit comparison of the decoded software output with an expected output determined from the original audio file. In addition, the testing apparatus can receive the analog output via the recording mechanism. By comparing the analog output with the decoded digital stream, the testing apparatus can isolate and measure the hardware portion of the audio output.

The audio test files can include any suitable audio content, and be encoded or defined using any suitable attribute. To completely test the audio output components of an electronic device, the testing apparatus can test the quality of audio playback of audio files defined using different attributes. In particular, the testing apparatus can define audio files that sweep through the possible parameters to test some, most or all variations of audio file attributes that the electronic device may play back. Each audio files can be characterized by any suitable combination of file attributes. The file attributes can include, for example containers (e.g., aiff, mp4, wav, avi, or Ogg), codecs (e.g., ALAC, aac, mp3, h.264, m4p, or wma), data rates, strategy (e.g., fixed or variable), bit depths (e.g., 16 or 24 bit depths), channels (e.g., two channels for stereo, or six channels for a surround sound system), or any other suitable attribute defining the manner in which audio content is stored in a digital file. Each attribute can have one of several values supported by the electronic device. To ensure that the audio output components operate properly for typical files played back by the device, the electronic device can play back audio test files using some or all variations of attribute values (e.g., audio files corresponding to a parameter sweep). The number of audio test files generated for a parameter sweep can vary based on the number of parameters and available parameter values. In one implementation, the number of audio test files can be, for example, in the range of 200 to 5000 (e.g., about 1000 files to play back an analyze).

When a large number of audio test files are sequentially played back and analyzed, the testing apparatus may have difficulty keeping track of which particular test file is associated with a resulting recording. In particular, if a test file is improperly recorded, not recorded at all, or otherwise lost, a user may not be able to rely simply on the order in which test files were played back and recordings were created to determine the test file and recordings associations. To ensure that a user of the testing apparatus can identify the attributes of a file from associated with a recording, the content of the audio file can be selected to correspond to the particular attributes of the audio file.

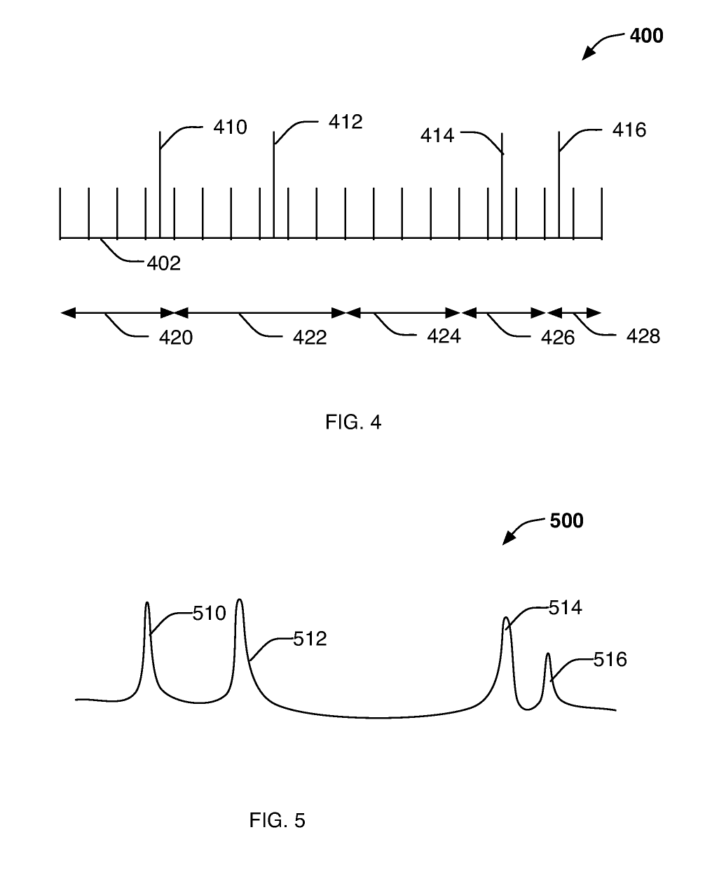

Any suitable type of content can be associated with attribute values of a test file. In some embodiments, the testing apparatus can define a sequence of frequency buckets (e.g., a sequence of segments each defined by a frequency range) in a continuum of audio frequencies, such that each bucket or segment is associated with a particular attribute value. Attribute values can be associated with any of the particular frequency ranges. In particular, the attributes can be distributed along frequency values in a manner that reduces or limits audio files having attribute values associated with adjacent or near frequency ranges (e.g., the frequency range associated with a low bit rate is a large number of frequency ranges from a container value). The audio file content can then be defined as audio tones within the frequency ranges of the attributes of the corresponding audio test file. FIG. 4 is a schematic view of audio content for an audio test file in accordance with one embodiment of the invention. Representation 400 can include several buckets 402 of defined frequency ranges having particular widths (e.g., particular ranges of frequencies). The width of each bucket may depend, for example, on the available frequency range for the audio file, the number of parameters to test, or any other suitable criteria. The audio file can be defined by a sequence of tones at frequencies within individual buckets. For example representation 400 can include 1 kHz tones 410, 412, 414 and 416 distributed among buckets 402. Each of the tones can be associated with particular file attributes. For example, collections 420, 422, 424, 426 and 428 of buckets 402 can be each associated with file attributes. In some embodiments, an audio file may not include a particular attribute (e.g., only include a mono channel, and not include 6 distinct channels from a surround sound system).

The analog audio output associated with each generated audio test file can include several peaks, each peak associated with one of the 1 kHz tones of the audio file. FIG. 5 is a schematic view of a representation of an analog audio signal generated by an electronic device in accordance with one embodiment of the invention. Representation 500 can include several peaks 510, 512, 514 and 516 each associated with a particular tone of the generated audio file (e.g., associated with tones 41, 412, 414 and 416 of representation 400, FIG. 4). To analyze the generated audio signal, the testing apparatus can apply a FFT to define discrete bars associated with the peaks of the analog signal.

When analyzing generated audio outputs, the testing apparatus can review the FFT of the generated audio outputs to identify the particular peaks of the recording. The testing apparatus can then compare the identified peaks of the recorded audio output with the peaks of the audio test file corresponding to the audio output. If the identified peaks (e.g., the frequencies of the identified peaks) correspond to the peaks of the generated audio test file, the testing apparatus can be assured that the proper audio test file was played back. The testing apparatus can then analyze the peaks to ensure that the generated audio is satisfactory (e.g., the peaks have sufficient amplitude, no unexpected peaks appear, no peaks disappear, or no leakage between peaks, for example between left and right audio channels). The testing apparatus can provide the FFT corresponding to the audio output recording to a results database for comparison to a baseline, storage, or certification.

To save test results for future reference, the testing apparatus can provide the FFT to the results database for storage. In some embodiments, particular test results can replace a baseline measurement for future tests. For example, if a test result from a particular file attribute selection is better than a baseline (e.g., a peak has less leakage), the results database can replace the previous baseline with the test result for the particular audio test file attributes.

In some embodiments, a testing apparatus similar to the one described above can be used to test other types of electronic device outputs. For example, a testing apparatus can be used to test the quality of a visual output, where each visual output can be generated by both hardware and software components, and the visual output can be defined by files having different attributes. To identify particular recorded visual outputs and identify the file attributes of the corresponding visual test files, the visual content can include particular lines of data displayed at particular locations or of particular frequencies associated with file attributes (e.g., associate a particular color with a codec, or a particular location on the screen with a sampling rate).

In some embodiments, the testing apparatus can be used to test other features of the playback components of an electronic device. For example, the testing apparatus can be used to test the volume of played back audio. In one implementation, the testing apparatus can provide an audio file that includes a single 1 kHz tone, generated using particular known attributes, and direct the electronic device to play back the audio file at each available volume level (e.g., each of 256 available volume levels). The testing apparatus can then analyze the recorded audio output to determine whether the output volume corresponds to the expected volume level.

Although many of the embodiments of the present invention are described herein with respect to personal computing devices, it should be understood that the present invention is not limited to personal computing applications, but is generally applicable to other applications.

The invention is preferably implemented by software, but can also be implemented in hardware or a combination of hardware and software. The invention can also be embodied as computer readable code on a computer readable medium. The computer readable medium is any data storage device that can store data which can thereafter be read by a computer system. Examples of the computer readable medium include read-only memory, random-access memory, CD-ROMs, DVDs, magnetic tape, and optical data storage devices. The computer readable medium can also be distributed over network-coupled computer systems so that the computer readable code is stored and executed in a distributed fashion.

Insubstantial changes from the claimed subject matter as viewed by a person with ordinary skill in the art, now known or later devised, are expressly contemplated as being equivalently within the scope of the claims. Therefore, obvious substitutions now or later known to one with ordinary skill in the art are defined to be within the scope of the defined elements.

The above-described embodiments of the present invention are presented for purposes of illustration and not of limitation, and the present invention is limited only by the claims which follow.

What is claimed is:

1. A method for analyzing the audio output of an electronic device, comprising:
directing an electronic device to play back a particular audio test file, wherein the content of the audio test file indicates the manner in which the audio test file stored the content;
recording an output of the electronic device corresponding to the audio test file; and
providing the recorded output to a testing apparatus, wherein the testing apparatus compares the recorded output to a baseline.

2. The method of claim 1, further comprising:
transmitting at least one audio test file to the electronic device, wherein the at least one audio test file is characterized by attributes defining the manner in which audio content is stored in the audio test file.

3. The method of claim 2, wherein the attributes comprise at least one of:
file container;
codec;
bit rate;
bit depth;
strategy; and
channels.

4. The method of claim 1, further comprising:
converting the analog output of the electronic device to a digital file.

5. The method of claim 4, wherein converting further comprises:
applying a FFT to the received analog output.

6. The method of claim 1, further comprising:
providing the recorded output to a records database for storage.

7. The method of claim 1, further comprising:
determining that the recorded audio output is superior to the baseline; and
replacing the baseline with the recorded audio output.

8. The method of claim 1, further comprising:
identifying the content of a recorded audio output;
identifying an audio test file expected to have produced the recorded audio output
determining the audio test file attributes associated with the identified content; and
comparing the determined audio test file attributes with the attributes of the identified audio test file.

9. The method of claim 8, wherein identifying further comprises:
identifying a plurality of tones of known frequency range;
identifying the frequency of the each of the plurality of tones; and
determining the audio test file attributes associated with the identified frequencies of each of the plurality of tones.

10. The method of claim 9, wherein:
each of the plurality of tones comprises a 1 kHz tone.

11. A system for testing the quality of audio output by an electronic device, comprising communications circuitry, a DAC, and a processor, the processor operative to:
direct the communications circuitry to provide an audio test file to an electronic device, wherein the manner in which analog content is stored in the audio test file is encoded by the content of the audio test file;
receive an audio output from the electronic device corresponding to the audio test file;
convert the received audio output to a digital form using the DAC;
determine the audio file attributes encoded by the audio output content; and
compare the determined audio file attributes with the known audio file attributes of the audio test file.

12. The system of claim 11, wherein the processor is further operative to:
determine whether the audio output matches a baseline.

13. The system of claim 12, wherein the processor is further operative to:
determine that the audio output exceeds the baseline; and
replace the baseline with the audio output for the audio file attributes of the audio test file.

14. The system of claim 11, wherein the processor is further operative to:
provide the audio output to a results database for storage.

15. A system of claim 11, wherein the processor is further operative to:
identify a plurality of frequency ranges, wherein each frequency range is associated with a particular audio file attribute value;
identify peaks in the audio output representing content; and
determine the frequency ranges of the identified peaks to identify the audio file attributes of the played back audio test file.

16. A method for defining an audio test file for testing the quality of audio playback of an electronic device, comprising:
defining a plurality of frequency ranges within a frequency continuum, wherein each of the plurality of frequency ranges is associated with a particular attribute value;
identifying a plurality of attribute values defining the manner in which audio is stored in an audio test file;
determining the plurality of frequency ranges associated with the identified plurality of attribute values;
generating a plurality of audio tones at frequencies within each of the determined plurality of frequency ranges; and
storing each of the generated plurality of audio tones in an audio test file using the identified plurality of attribute values.

17. The method of claim 16, wherein each of the plurality of audio tones comprise 1 kHz tones.

18. The method of claim 16, further comprising:
identifying a particular frequency substantially in the center of a frequency range; and
generating an audio tone at the identified particular frequency.

19. The method of claim 16, further comprising:
defining a plurality of frequency ranges having equal size.

20. The method of claim 16, wherein the attribute values comprise values of at least one of:
file container;
codec;
bit rate;
bit depth;
strategy; and
channels.

21. Computer readable media for analyzing the audio output of an electronic device, comprising a computer-readable instructions for:
directing an electronic device to play back a particular audio test file, wherein the content of the audio test file indicates the manner in which the audio test file stored the content;
recording an output of the electronic device corresponding to the audio test file;
providing the recorded output to a testing apparatus, wherein the testing apparatus compares the recorded output to a baseline.

22. The computer readable media of claim 21, further comprising additional computer-readable instructions for:
transmitting at least one audio test file to the electronic device, wherein the at least one audio test file is characterized by attributes defining the manner in which audio content is stored in the audio test file.
